(19) United States
(12) Patent Application Publication
(10) Pub. No.: US 2009/0112461 A1
(43) Pub. Date: Apr. 30, 2009

(54) MAPPING SYSTEM AND METHOD

(76) Inventor: John Murphy, Coppell, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/100,941

(22) Filed: Apr. 10, 2008

Related U.S. Application Data
(60) Provisional application No. 61/001,147, filed on Oct. 31, 2007.

(51) Int. Cl. G01C 21/30

(52) U.S. Cl. 701/208

(57) ABSTRACT

A mapping method is presented comprising receiving travel-related information from a user. A user interface is presented displaying at least a portion of a transportation hub. The user interface indicates a path and an estimated travel time from a current location within the transportation hub to a target location within the transportation hub using the received travel-related information.

### CROSS-REFERENCE TO RELATED PATENT APPLICATIONS

This patent application claims the benefit of U.S. Provisional Patent Application No. 61/001,147, filed Oct. 31, 2007, the teachings and disclosure of which are hereby incorporated in their entireties by reference thereto.

### BACKGROUND

Travelers are often confused as to their whereabouts in large areas such as, but not limited to, airports, train stations, and bus terminals. For example, upon arriving on one flight, and having to find a connecting flight at the same airport, a traveler must ascertain the correct connecting departure gate, and the direction to that gate. In addition, a traveler might have difficulty finding other useful locations such as, but not limited to, a baggage claim area, ground transportation, customs and immigration services, money exchange, car rental, first aid, waiting lounge, restaurants, rest rooms, telephones, and ticket counters. Because the particular airport is often unfamiliar, the traveler usually asks others for directional information. Such information may not be accurate and/or confusing, causing lost time and consuming considerable effort.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 illustrates an embodiment of a mapping system;

FIG. 2 illustrates an embodiment of a mapping application configured on the mapping system of FIG. 1;

FIGS. 3A and 3B illustrates an embodiment of a mapping method;

FIG. 4 illustrates another embodiment of a mapping method; and

FIG. 5 illustrates an embodiment of a mapping display generated by the mapping system of FIG. 1.

### DETAILED DESCRIPTION OF THE DRAWINGS

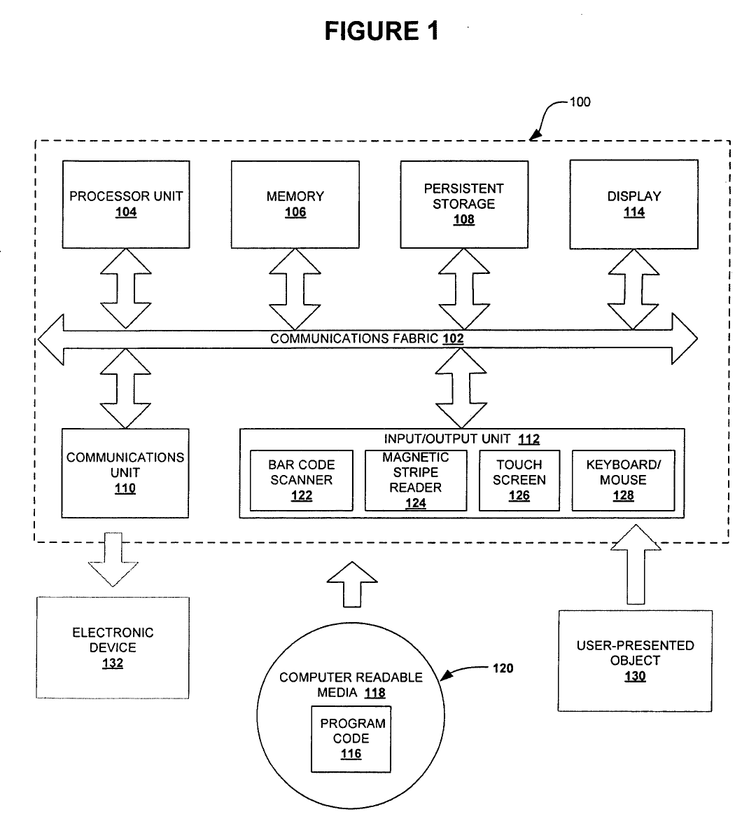

FIG. 1 is a diagram illustrating an embodiment of mapping system 100. In this illustrative embodiment, mapping system 100 comprises communications fabric 102, which provides communications between a processor unit 104, a memory 106, persistent storage 108, a communications unit 110, an input/output (I/O) unit 112, and a display 114. In some embodiments, a bus system may be used to implement communications fabric 102 and may be comprised of one or more buses, such as a system bus or an input/output bus. The bus system may be implemented using any suitable type of architecture that provides for a transfer of data between different components or devices attached to the bus system.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106, in some embodiments, may be a random access memory or any other suitable volatile or non-volatile storage device. Persistent storage 108 may take various forms depending on the particular implementation. For example, persistent storage 108 may contain one or more components or devices. In some embodiments, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110 provides for communications with other data processing systems or devices. In some embodiments, communications unit 110 is a network interface card. Communications unit 110 may provide communications through the use of either physical and/or wireless communications links. In some embodiments, communications unit 110 may be used to update data stored on mapping system 100 in real time with changing travel information. For example, mapping system 100 may be updated in real time with travel related information such as delayed flight schedules, gate reassignments, flight reassignments, and/or change in travel mode such as, but not limited to, non-functioning elevators, trams, escalators, etc. In addition, in some embodiments, mapping system 100 may use communications unit 110 to transfer data to an electronic device 132 associated with a user, such as, but not limited to, a personal digital assistant (PDA), a notebook computer, and a cellular device.

Input/output unit 112 enables input and output of data with other devices that may be connected to mapping system 100. For example, input/output unit 112 may provide a connection for a keyboard/mouse 128 for receiving user input. Further, input/output unit 112 may send output to a printer. In some embodiments, input/output unit 112 may comprise a bar code scanner 122 for receiving user input through the use of a bar code and/or a magnetic stripe reader 124 for receiving user input through the use of a card having a magnetic stripe such as, but not limited to, a payment card and/or a driver license. Additionally, in some embodiments, input/output unit 112 may comprise a touch screen 126 for receiving user input through display 114. Display 114 provides a mechanism to display information to a user. Display 114 may comprise one or more display apparatus.

Instructions and data for the operating system and applications are located on persistent storage 108. These instructions may be loaded into memory 106 for execution by processor unit 104. The processes of the different embodiments may be performed by processor unit 104 using computer implemented instructions, which may be located in a memory such as memory 106. These instructions are referred to as program code, computer usable program code, or computer readable program code that may be read and executed by a processor in processor unit 104. The program code in the different embodiments may be embodied on different physical or tangible computer readable media such as, but not limited to, memory 106 or persistent storage 108.

Program code 116 is located and/or stored in a functional form on computer readable media 118 that is selectively removable and may be loaded onto or transferred to mapping system 100 for execution by processor unit 104. Program code 116 and computer readable media 118 form computer program product 120 in these examples. Computer readable media 118 may be, but is not limited to, an optical or magnetic disc that is inserted or placed into a drive or other device that is part of persistent storage 108 for transfer onto a storage device such as a hard drive that is part of persistent storage 108. Computer readable media 118 may also take the form of a persistent storage such as a hard drive, a thumb drive, or a flash memory that is connected to mapping system 100. In some instances, computer readable media 118 may not be removable. In some embodiments, program code 116 may be transferred to mapping system 100 through a communications link to communications unit 110 and/or through a connection to input/output unit 112. The communications link and/or the connection may be physical or wireless.

The illustrative embodiments may be implemented in a memory structure such as memory 106. The illustrative embodiments provide a memory architecture containing embedded components such as, but are not limited to, embedded processing unit(s) such as processing unit 104 and communication unit(s) such as communications unit 110.

The components illustrated for mapping system 100 are not intended to provide architectural limitations to the manner in which different embodiments may be implemented. The different illustrative embodiments may be implemented in a data processing system including components in addition to or in place of those illustrated for mapping system 100. Other components shown in FIG. 1 can be varied from the illustrative examples shown. All or a portion of the illustrative embodiment of mapping system 100 may be located in a location accessible to travelers, such as, but not limited to, a centralized location in a transportation hub, randomly distributed kiosk terminals, and/or an accessible location onboard an airplane and/or other modes/vehicles of travel.

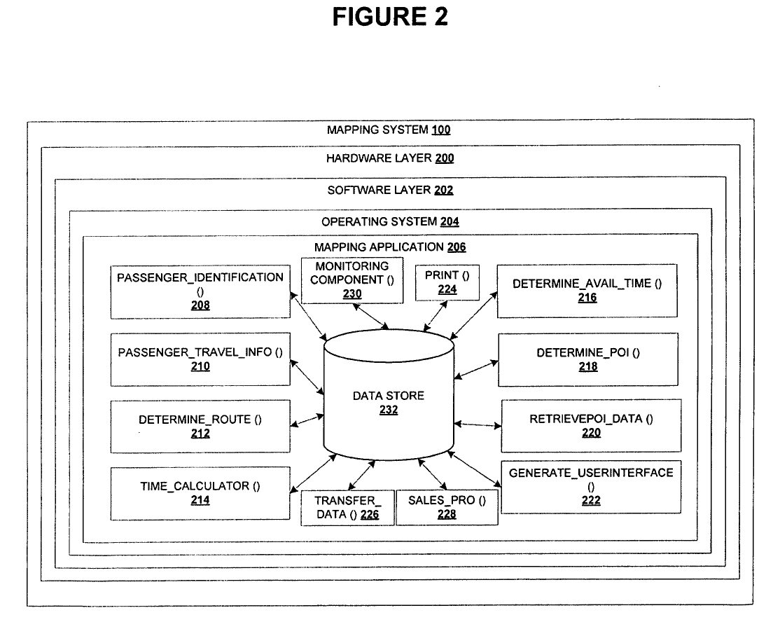

FIG. 2 is a diagram illustrating an embodiment of a mapping application 206 that may be implemented on mapping system 100. In the embodiment illustrated in FIG. 2, mapping system 100 comprises of a hardware layer 200 and software layer 202. Hardware layer 200 is a layer of programming that enables software applications such as, but not limited to, operating system 204 running in software layer 202 to interact with a hardware device of mapping system 100. Operating system 204 may be, but not limited to, a commercially available operating system such as Microsoft® Windows Vista™ (Microsoft and Windows Vista are trademarks of Microsoft Corporation in the United States, other countries, or both).

In the embodiment illustrated in FIG. 2, mapping application 206 comprises components such as, but not limited to, a data store 232 for storing and retrieving information. Mapping application 206 may also comprise executable methods (208-230) for providing assistance to a user in a particular area such as, but not limited to, a transportation hub (e.g., an airport, train station, etc.) and tourist attractions (e.g., amusement parks, museums, zoos, large governmental/commercial buildings). In addition, mapping application 206 may provide travel assistance to an enroute passenger. An enroute passenger as referenced herein is a person that is currently traveling in a mode of transportation associated with a particular transportation hub.

Passenger_Identification ( ) 208 identifies the person/user currently using mapping system 100. Passenger_Identification ( ) 208 may use travel-related information received manually through but not limited to, keyboard/mouse 128 and/or through touch screen 126 to identify the user. In some embodiments, Passenger_Identification ( ) 208 may use travel-related information received by reading a user presented object 130 such as, but not limited to, a travel ticket, a boarding pass, an identification card, and/or a credit card, using bar code scanner 122 and/or magnetic stripe reader 124. For example, travel-related information may be determined by scanning a bar code of a passenger ticket and retrieving the passenger information associated with the particular ticket from a data store such as data store 232. Additionally, in some embodiments, travel-related information may be obtained independent of the identity of the user (e.g., mapping system 100 receives flight number). Thus, in some embodiments, identifying the identity of the user is not necessary. Mapping system 100 may comprise other means for reading and/or receiving the travel-related information.

Passenger_Travel_Info ( ) 210 retrieves travel-related information associated with the identified user and/or received travel-related information from a data store such as, but not limited to, data store 232. Data store 232 may be a local and/or a remote data store. In some embodiments, the travel-related information may be retrieved from the received information such as, but not limited to, information encoded on a scanned bar code or encoded information in a magnetic stripe. In addition, in some embodiments, the travel information may be manually entered by the user. The travel-related information may include a travel itinerary such as, but is not limited to, departure gate, departure time, and destination. Other information may also be retrieved such as age and gender in determining potential points of interest as will be further described below.

Determine_Route ( ) 212 determines the shortest path and/or quickest path from a current location of the particular user to a target location, such as a travel departure gate, from the travel itinerary of the identified user. In some embodiments, Determine_Route ( ) 212 may specify details associated with the determined path such as locations of trams, moving walkways, elevators, escalators, etc. Further, in some embodiments, Determine_Route ( ) 212 may also determine the shortest and/or quickest path to other often-sought locations such as, but not limited to, a baggage claim area, ground transportation, customs and immigration services, money exchange, car rental, first aid, waiting lounge, restaurants, rest rooms, telephones, and ticket counters. In some embodiments, Determine_Route ( ) 212 determines the shortest path and/or quickest path from an arriving location to a departing and/or connecting location. For example, an in-flight passenger may use mapping system 100 to determine the shortest path and/or quickest path to take to make a connecting flight (e.g., using all or a portion of mapping system 100 located on an airplane or other type of travel vehicle).

Time_Calculator ( ) 214 calculates the estimated time to travel the determined path from the current location and/or the arrival gate to a target location such as, but not limited to, a departure gate. Time_Calculator ( ) 214 may use any algorithm to determine the estimated time such as, but not limited to, dividing the distance by an average walking speed. In some embodiments, Time_Calculator ( ) 214 may use a look-up table stored in data store 232 for looking up the average time for all predetermined paths from an origination point to a destination point, also taking into consideration various modes of travel (e.g., walking, trams, moving walkways, elevators, escalators, etc.) In some embodiments, Time_Calculator ( ) 214 may use a personalized approach in estimating the average walking speed of an identified person based on height and weight to determine an estimated travel time.

Determine_Avail_Time ( ) 216 calculates the difference between an anticipated travel-related event, such as a scheduled departure time and/or boarding time, and the current time to determine a remaining amount of time before the anticipated travel-related event. In the situation where the passenger is enroute, Determine_Avail_Time ( ) 216 calculates the difference between the scheduled connecting departure time and the estimated arrival time of the current flight/ride to determine the available time before the next scheduled departure. In some embodiments, mapping system 100 may present a warning/alert if the available time is close to or less than the estimated travel time.

Determine_POI ( ) 218 determines the points of interest along the determined route. The points of interest may be the same for all travelers or may, in some embodiments, be based on the estimated travel time and the remaining amount of time before the anticipated travel-related event (i.e., the available time). For example, if the available time is close to or less than the estimated travel time, mapping system 100 may determine no points of interest because the traveler is running late and would not likely stop, or should avoid stopping, before reaching the departure area. On the other hand, mapping system 100 may display numerous points of interest regardless of the available time or if the available time is extremely long as compared to the estimated travel time. In some embodiments, Determine_POI ( ) 218 may determine personalized points of interest based on, but not limited to, gender and age and/or any previously stored history associated with the current user.

Retrieve_PO_Data ( ) 220 retrieves information from data store 232 associated with the determined points of interest. For example, in some embodiments, if a determined point of interest is a dining facility, Retrieve_PO_Data ( ) 220 may retrieve identification information associated with the dining facility (e.g., the name of the dining facility), the menu and/or other data such as, but not limited to, hours of operation for the particular point of interest. Additionally, in some embodiments, if the point of interest is a merchant, an advertisement, coupons, and/or a sales catalog may be retrieved.

Generate_UserInterface ( ) 222 generates a user interface using all or a portion of the retrieved and calculated data of the above methods. In some embodiments, the generated user interface depicts a personalized welcome message, the current location of the user, a path indicating the direction in which to travel to a departure area, points of interest along the path, the estimated travel time to reach the departure area, the available time, and/or travel itinerary information such as, but not limited to, flight number, destination, departure time, and departure gate. The generated user interface is presented on a display, such as display 114, to the user. In some embodiments, Generate_UserInterface ( ) 222 may gradually generate the shortest and/or quickest travel path on the user interface enabling the user to view the path as it is being drawn. In some embodiments, Print ( ) 224 may be called to print all or a portion of the information associated with the generated user interface and/or in some embodiments may print a boarding pass associated with the received travel-related information upon receiving a user request. Additionally, in some embodiments, Transfer_Data ( ) 226 may be called to transfer all or a portion of the information presented on the user interface to electronic device 132 associated with the user.

In some embodiments, the depicted points of interest provide interactive functionality with the user. For example, a user may indicate using, but not limited to, touch screen 126 and/or mouse/keyboard 128 to select a depicted point of interest. In response, mapping system 100 presents the retrieved data associated with the selected point of interest. In some embodiments, if the selected point of interest is a merchant, mapping system 100 may provide functionality to enable a user to select and purchase merchandise offered by the selected merchant using Sales_Proc ( ) 228. In addition, in some embodiments, mapping system 100 may retrieve and present merchandise associated with an online retailer. Further, in some embodiments, Sales_Proc ( ) 228 may process credit/debit card payments using magnetic stripe reader 124.

In some embodiments, mapping system 100 may monitor user interaction with mapping application 206 using Monitoring Component ( ) 230 and store the user history in data store 232. The monitored data may be used by retailers for marketing purposes and/or may be used by mapping system 100 to personalize and/or improve future interaction with the user.

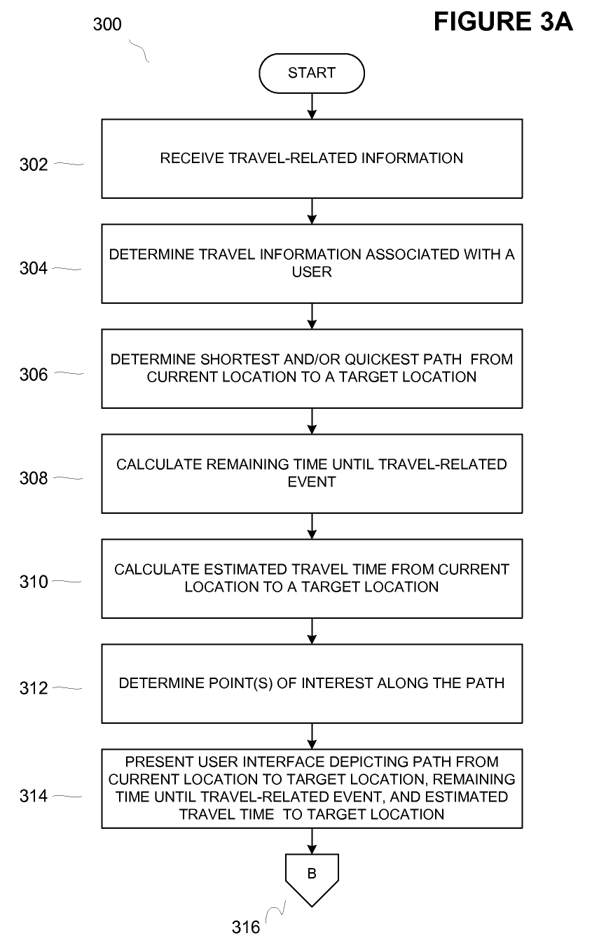

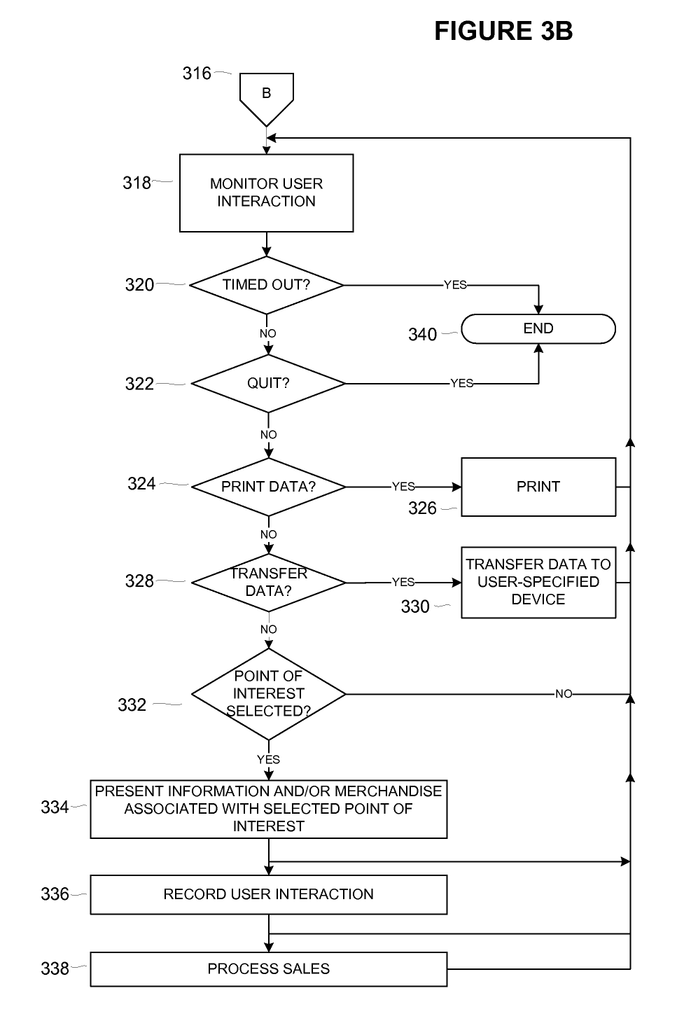

FIGS. 3A and 3B illustrate an embodiment of a mapping method using mapping system 100. The method of FIGS. 3A and 3B may be implemented in an instruction set stored on a computer readable medium and executed by a processor such as, but not limited to, processor unit 104. The method begins by receiving travel-related information from a user at block 302. The method determines travel information associated with the user at block 304. At block 306, the method determines the shortest and/or quickest path from the current location to a target location, such as, but not limited to, the departure area identified from the travel information. The remaining time before a travel-related event, such as a scheduled departure time, is calculated at block 308. The estimated travel time from the current location to the target location is calculated at block 310. At block 312, the points of interest along the travel path are determined. A user interface is generated and presented at block 314 indicating the travel path from the current location to the target location, the remaining time until the scheduled travel-related event, and an estimated travel time to the target location.

The method of FIG. 3A continues on to FIG. 3B through the connection point at block 316. At block 318, the method monitors the user interaction. The method determines if the system has timed out at block 320. A timeout may occur at a predetermined time after no user interaction is detected. If the timeout has been detected, the method ends at block 340. The method may also end if a quit command is received at block 322. The method monitors for a print data command at block 324. If a print data command is received at block 324, the method prints all or a portion of the displayed information at block 326. The method monitors for a transfer data command at block 328. If a transfer data command is received at block 328, the process transfers all or a portion of the displayed data to a user-specified device at block 330. For example, the user may enter an e-mail address or a telephone number indicating where to send the data. In some embodiments, mapping system 100 may provide a cable connection to enable a user to directly connect a data port of a specified device to mapping system 100 to enable data transfer.

In the embodiments having interactive points of interest, the method determines if a point of interest is selected at block 332. In response to a user selecting a point of interest, the method presents information and/or merchandise associated with the selected point of interest at block 334. The method records the user interaction at block 336 and stores the data in data store 232. The method processes sales of merchandise, if any, at block 338.

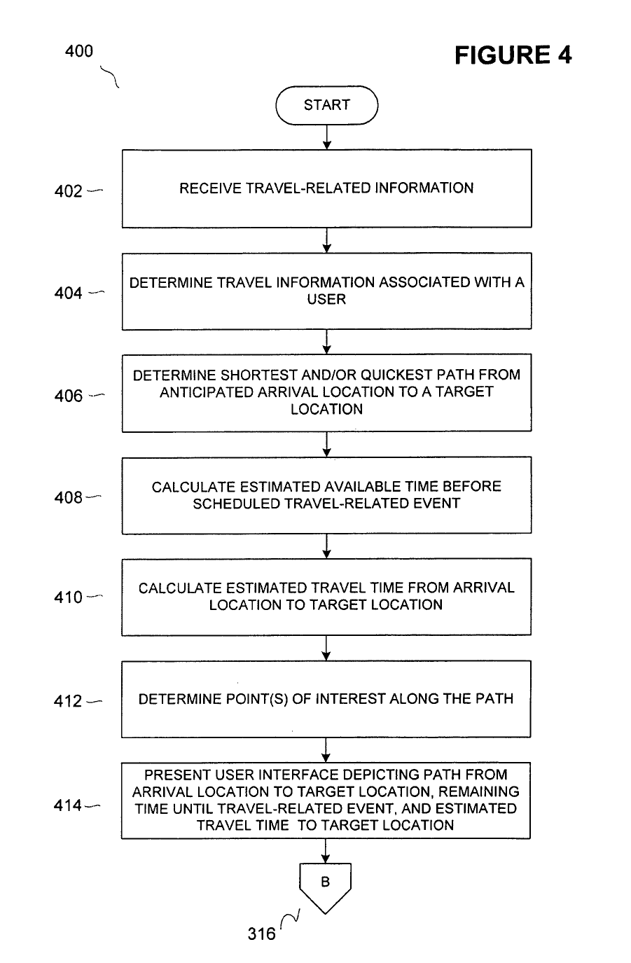

With reference now to FIG. 4, a flow diagram is presented illustrating another embodiment of a mapping method for providing travel assistance to an enroute passenger. The method of FIG. 4 may be implemented in an instruction set stored on a computer readable medium and executed by a processor such as, but not limited to, processor unit 104. The method begins by receiving travel-related information from a user at block 402. The method determines travel information associated with the user at block 404. At block 406, the method determines the shortest and/or quickest path from an anticipated arrival location to a target location such as a connecting departure area identified from the travel information. The estimated available time from the scheduled arrival time before a scheduled travel-related event, such as, but not limited to, a departure time is calculated at block 408. The estimated travel time from the anticipated arrival location to the target location is calculated at block 410. At block 412, the points of interest along the travel path are determined. A user interface is generated and presented at block 414 indicating the travel path from the anticipated arrival location to the target location, the remaining time until the travel-related event, and an estimated travel time from the anticipated arrival location to the target location. The method of FIG. 4 continues on to FIG. 3B through the connection point at block 316.

The illustrative methods of FIGS. 3A, 3B, and 4 are not intended to imply implementation limitations of mapping system 100. For example, in some embodiments, the depicted blocks of FIGS. 3A, 3B, and 4 may be omitted, combined, rearranged, and/or additional blocks may be added to implement the methods of mapping system 100.

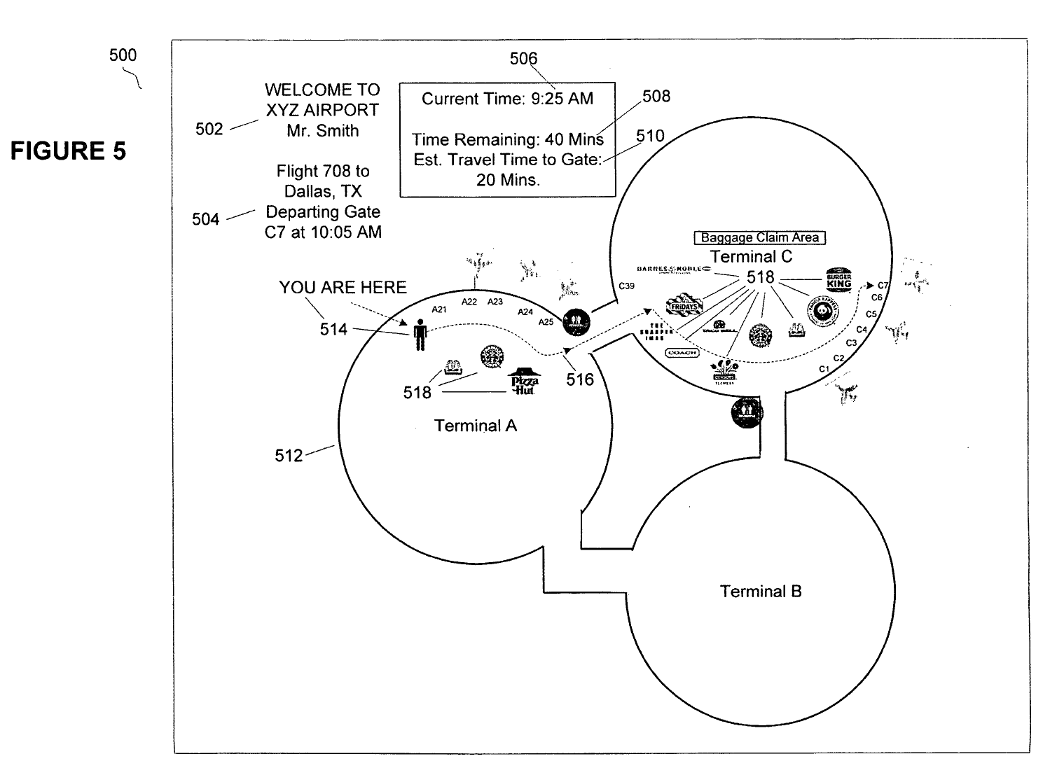

FIG. 5 is a diagram illustrating an embodiment of a user interface 500 generated by mapping system 100. In some embodiments, a personalized welcome message 502 is presented to the identified user. A travel itinerary 504 of the user such as, but not limited to, the flight number, destination location, departure gate, and departure time is presented. A current time 506 may also be displayed. A calculated remaining time 508 until a scheduled travel-related event and an estimated travel time 510 from the current location to the departure gate are displayed. A diagram 512 representing the shape and/or configuration of the travel area is presented (e.g., shape and/or configuration of an airport terminal). A message and/or illustration 514 depict(s) the user's current location. A calculated path 516 depicts the shortest and/or quickest path from the current location to the departure location. The determined points of interest 518 are depicted along path 516 indicating potential points of interest for the user. The depicted points of interest 518 may comprise trademarks of their respective owners. In some embodiments, points of interest 518 may be selected using touch screen 126 and/or mouse/keyboard 128 to provide the user with additional information and/or merchandise associated with the selected point of interest. The illustrative embodiments may be implemented in different languages and/or a function may be provided in which a user may select a desired language.

Accordingly, the illustrative embodiments provide a mapping system 100 for guiding a person in a particular area such as, but not limited to, airports, train stations, shopping malls, large building complexes, and amusement parks. In addition, the illustrative embodiments provide a mapping system 100 for providing travel assistance to an enroute passenger such as, but not limited to, an in-flight passenger. In addition, the illustrative embodiments enable a user to quickly and accurately identify the shortest and/or quickest path, the estimated travel time, and potential points of interest from one location to another.

What is claimed is:

1. A mapping method comprising:
receiving travel-related information from a user; and
presenting a user interface displaying at least a portion of a transportation hub, wherein the user interface indicates a path and an estimated travel time from a current location within the transportation hub to a target location within the transportation hub using the received travel-related information.

2. The method of claim 1 wherein receiving the travel-related information comprises reading a user-presented object.

3. The method of claim 1 further comprising determining a remaining amount of time until a travel-related event.

4. The method of claim 1 wherein the path is gradually generated on the user interface.

5. The method of claim 1 further comprising indicating on the user interface a remaining amount of time until a travel-related event.

6. The method of claim 1 further comprising determining a point of interest along the path.

7. The method of claim 1 further comprising indicating on the user interface a point of interest along the path.

8. The method of claim 1 further comprising indicating a point of interest along the path based on the estimated travel time and a remaining amount of time until a travel-related event.

9. The method of claim 1 further comprising:
indicating an interactive point of interest along the path; and
presenting information about the point of interest in response to a selection of the point of interest by the user.

10. The method of claim 1 further comprising:
indicating an interactive point of interest along the path; and
presenting merchandise associated with the point of interest in response to a selection of the point of interest by the user.

11. The method of claim 10 further comprising processing payment for selected merchandise.

12. The method of claim 10 further comprising recording user interaction information associated with the presented merchandise.

13. The method of claim 1 further comprising transferring information associated with the user interface to an electronic device associated with the user.

14. A mapping system comprising:
an input component for receiving travel-related information from a user; and
a display unit for presenting a user interface displaying at least a portion of a transportation hub, wherein the user interface indicates a path and an estimated travel time from a current location within the transportation hub to a target location within the transportation hub using the received travel-related information.

15. The mapping system of claim 14 wherein the input component comprises at least one of a bar code scanner, a magnetic stripe reader, a touch screen, and a keyboard.

16. The mapping system of claim 14 wherein the display unit indicates a remaining amount of time until a travel-related event.

17. The mapping system of claim 14 wherein the display unit indicates a point of interest along the path.

18. The mapping system of claim 14 further comprising a processing unit for presenting on the display unit information associated with a selected point of interest.

19. The mapping system of claim 18 further comprising a processing unit for processing payment for merchandise purchased corresponding to the selected point of interest.

20. The mapping system of claim 14 further comprising a communication unit for transferring information associated with the user interface to an electronic device associated with the user.

21. The mapping system of claim 14 further comprising a communication unit for real time updating of information associated with the travel-related information.

22. A computer readable medium having stored thereon an instruction set to be executed, the instruction set, when executed by a processor, causes the processor to:
receive travel-related information from a user; and
present a user interface displaying at least a portion of a transportation hub, wherein the user interface indicates a path and an estimated travel time from a current location within the transportation hub to a target location within the transportation hub using the received travel-related information.

23. The computer-readable medium of claim 22 wherein the instruction set, when executed by a processor, causes the processor to indicate a remaining amount of time until a travel-related event.

24. The computer-readable medium of claim 22 wherein the instruction set, when executed by a processor, causes the processor to indicate a point of interest along the path.

25. A mapping method comprising:
receiving travel-related information associated with an enroute passenger; and
presenting a user interface indicating a path from an anticipated arrival location of the enroute passenger to a target location within a transportation hub using the received travel-related information.

26. The method of claim 25 further comprising presenting an estimated travel time from the anticipated arrival location to the target location.

27. The method of claim 25 further comprising presenting a point of interest along the path.

28. The method of claim 25 further comprising presenting an estimated remaining time from an estimated time of arrival to an estimated time of a travel-related event.

29. The method of claim 25 further comprising:
presenting an interactive point of interest along the path;
presenting merchandise associated with the point of interest in response to a selection of the point of interest by the user; and
processing payment for selected merchandise.

30. A mapping system comprising:
an input component for receiving travel-related information associated with an enroute passenger; and
a display unit for presenting a user interface displaying at least a portion of a transportation hub, wherein the user interface indicates a path from an anticipated arrival location of the enroute passenger to a target location within a transportation hub using the received travel-related information.

31. The mapping system of claim 30 wherein the display unit presents an estimated travel time from the anticipated arrival location to the target location.

32. The mapping system of claim 30 wherein the display unit presents a point of interest along the path.

33. The mapping system of claim 30 wherein the display unit presents an estimated remaining time from an estimated time of arrival to an estimated time of a travel-related event.

34. A computer readable medium having stored thereon an instruction set to be executed, the instruction set, when executed by a processor, causes the processor to:
receive travel-related information associated with an enroute passenger; and
present a user interface indicating a path from an anticipated arrival location of the enroute passenger to a target location within a transportation hub using the received travel-related information.

35. The computer-readable medium of claim 34 wherein the instruction set, when executed by a processor, causes the processor to present an estimated travel time from the anticipated arrival location to the target location.

36. The computer-readable medium of claim 34 wherein the instruction set, when executed by a processor, causes the processor to present a point of interest along the path.

37. The computer-readable medium of claim 34 wherein the instruction set, when executed by a processor, causes the processor to present an estimated remaining time from an estimated time of arrival to an estimated time of a travel-related event.

38. A mapping method comprising:
determining travel-related information from reading a user-presented object; and
presenting a user interface indicating a path from a current location of the user to a target location using the received travel-related information.
